(19) United States
(12) Patent Application Publication
(10) Pub. No.: US 2022/0261822 A1
(43) Pub. Date: Aug. 18, 2022

(54) INFORMATION PROCESSING DEVICE, CONTROL METHOD, AND STORAGE MEDIUM

(71) Applicant: NEC Corporation, Minato-ku, Tokyo (JP)

(72) Inventors: Akihiro YABE, Tokyo (JP); Naoto OHSAKA, Tokyo (JP)

(73) Assignee: NEC Corporation, Minato-ku, Tokyo (JP)

(21) Appl. No.: 17/622,981

(22) PCT Filed: Jul. 4, 2019
(86) PCT No.: PCT/JP2019/026568

§ 371 Date: Dec. 27, 2021

(51) Int. Cl. G06Q 30/02

(52) U.S. Cl. CPC G06Q 30/0201

(57) ABSTRACT

The seller information acquisition unit 51B is configured to acquire seller information indicative of a sell condition of a transaction target, the sell condition being presented by each of a plurality of sellers. The buyer information acquisition unit 52B is configured to acquire buyer information indicative of a buy condition of the transaction target, the buy condition being presented by each of a plurality of buyers. The determination unit 54B is configured to determine combinations of each of the sellers and each of the buyers establishing the transaction, on the basis of the seller information acquired by the seller information acquisition unit 51B and the buyer information acquired by the buyer information acquisition unit 52B and a profit for a mediator mediating the transaction of the transaction target.

### TECHNICAL FIELD

The present invention relates to a technical field of an information processing device, a control method, and a storage medium for performing processing related to a transaction.

### BACKGROUND ART

Traditionally, a system is known for determining plans for transactions of fuels and the like. For example, Patent Literature 1 discloses a transaction server which extracts the combinations of LNG suppliers and LNG consumers dealing with a common medium and which further extracts a combination satisfying a contract agreement conditions from the extracted combination.

### PRIOR ART DOCUMENTS

### Patent Literature

Patent Literature 1: JP 2008-077346A

### SUMMARY OF THE INVENTION

### Problem to be Solved by the Invention

Mediators (dealers) such as commercial companies that mediate transactions must combine (match) sellers of target goods of the transactions with buyers to meet the transaction conditions, such as the trading volume and the price, desired by the sellers and the buyers. On the other hand, the profit of the mediator differs depending on the combinations of buyers and sellers. Therefore, when this matching is performed by automation, favorable combinations for the mediators may not be produced simply by determining the combinations that satisfy the contract agreement conditions.

In view of the above-described issues, it is therefore an example object of the present disclosure to provide an information processing device, a control method, and a storage medium capable of suitably determining combinations of sellers and buyers of a transaction target.

### Means for Solving the Problem

In one mode of the information processing device, there is provided an information processing device including: a seller information acquisition unit configured to acquire seller information indicative of a sell condition of a transaction target, the sell condition being presented by each of a plurality of sellers; a buyer information acquisition unit configured to acquire buyer information indicative of a buy condition of the transaction target, the buy condition being presented by each of a plurality of buyers; and a determination unit configured to determine combinations of each of the sellers and each of the buyers establishing valid transactions, on a basis of the seller information, the buyer information, and a profit of a mediator mediating the transactions of the transaction target.

In one mode of the control method, there is provided a control method executed by an information processing device, the control method including: acquiring seller information indicative of a sell condition of a transaction target, the sell condition being presented by each of a plurality of sellers; acquiring buyer information indicative of a buy condition of the transaction target, the buy condition being presented by each of a plurality of buyers; and determining combinations of each of the sellers and each of the buyers establishing valid transactions, on a basis of the seller information, the buyer information, and a profit of a mediator mediating the transactions of the transaction target.

In one mode of the storage medium, there is provided a storage medium storing a program executed by a computer, the program causing the computer to function as: a seller information acquisition unit configured to acquire seller information indicative of a sell condition of a transaction target, the sell condition being presented by each of a plurality of sellers; a buyer information acquisition unit configured to acquire buyer information indicative of a buy condition of the transaction target, the buy condition being presented by each of a plurality of buyers; and a determination unit configured to determine combinations of each of the sellers and each of the buyers establishing valid transactions, on a basis of the seller information, the buyer information, and a profit of a mediator mediating the transactions of the transaction target.

### Effect of the Invention

An example advantage according to the present invention is to suitably determine combinations of sellers and buyers that are preferable for the mediator of transactions.

### BRIEF DESCRIPTION OF THE DRAWINGS

FIG. 1 illustrates the configuration of an optimization system according to a first example embodiment.

FIG. 2 illustrates the hardware configuration of an information processing device.

FIG. 3 illustrates an example of the data structure of seller information.

FIG. 4 illustrates an example of the data structure of buyer information.

FIG. 5 illustrates an example of the data structure of vessel information.

FIG. 6 illustrates an example of the data structure of port information.

FIG. 7 illustrates an example of a functional block of the information processing device.

FIG. 8 illustrates a display example of the matching confirmation view.

FIG. 9 is a flowchart showing the procedure of the optimization process.

FIG. 10 illustrates the configuration of an optimization system according to a second example embodiment.

FIG. 11 illustrates a configuration of an information processing device according to a third example embodiment.

### DESCRIPTION OF EXAMPLE EMBODIMENTS

Hereinafter, an example embodiment of an information processing device, a control method, and a storage medium will be described with reference to the drawings.

### First Example Embodiment

[Configuration of Optimization System]

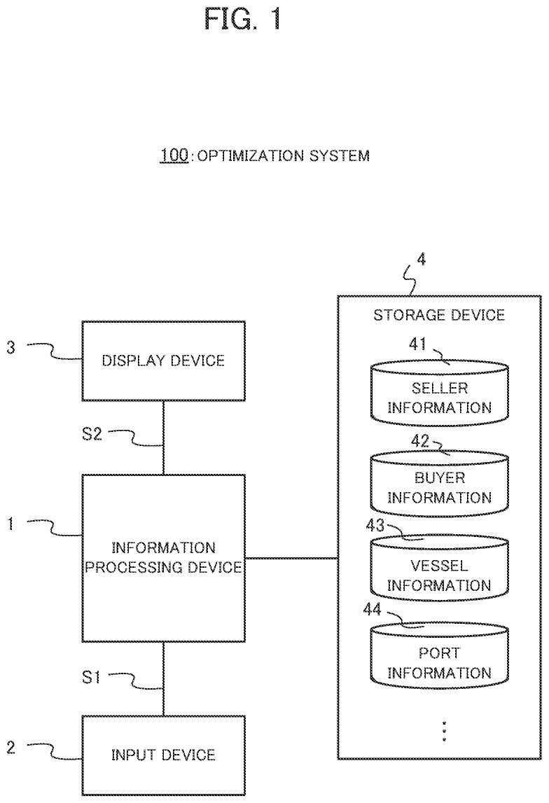

FIG. 1 shows the configuration of the optimization system 100 according to the first example embodiment. The optimization system 100 mainly includes an information processing device 1, an input device 2, a display device 3, and a storage device 4.

The information processing device 1 performs processing (simply referred to as “optimization processing”) for determining the combinations of the sellers of target goods (commodity) of transaction and the buyers thereof and optimizing the transportation schedule of the goods. The information processing device 1 is preferably used by a trading company (firm) who mediates the purchase and sale of goods (transaction target) to be traded. Examples of the goods to be traded may include fuel such as LNG, steel, machinery, electronics, textiles, chemical products, medical-related goods, and foodstuffs. In the case that the goods to be traded are goods (e.g., LNG that evaporates over time) which cause the loss over time, it is necessary to smoothly transport goods from the seller to the buyer, and the need for optimization of the transport schedule becomes particularly high.

The input device 2 is an interface that accepts the input by the user, and examples of the input device 2 include a touch panel, a button, a voice input device. The input device 2 supplies the input information “S1” generated based on the input by the user to the information processing device 1. In this case, for example, the information processing device 1 generates various kinds of information to be stored in the storage device 4 based on the input information S1 supplied from the input device 2, and specifies conditions or the like designated by the user with respect to the optimization processing.

The display device 3 displays information based on the display information “S2” supplied from the information processing device 1, and examples of the display device 3 include a display and a projector.

The storage device 4 is a memory for storing various kinds of information necessary for the optimization processing. The storage device 4 may be an external storage device such as a hard disk connected to or built in to the information processing device 1, or may be a storage medium such as a flash memory. The storage device 4 may be a server device that performs data communication with the information processing device 1. In this case, the storage device 4 may be configured by a plurality of server devices.

The storage device 4 stores seller information 41, buyer information 42, vessel information 43, and port information 44. The seller information 41 is information relating to the sellers of the goods to be traded via the user of the information processing device 1. The buyer information 42 is information relating to the buyers of goods to be traded through the user of the information processing device 1. The vessel information 43 is information relating to vessels which can be used to transport the goods to be traded by the mediator (e.g., trading company) that is the user of the information processing device 1. The port information 44 refers to information on ports (ports of loading or ports of discharge) to be used for transporting goods subject to transaction.

In addition to the information described above, the storage device 4 may store various kinds of information necessary for the optimization processing. For example, the storage device 4 may further store information necessary for calculating the price of the goods to be traded, and the like. Further, the seller information 41, the buyer information 42, the vessel information 43, and the port information 44 may be generated by a device other than the information processing device 1 in advance, or may be information which the information processing device 1 generates and/or updates based on the input information of the input device 2.

In some embodiments, the storage device 4 may store information regarding the loss with respect to the goods that deteriorate over time. In this case, for example, the information regarding the loss may be information on the amount of loss in units of time that is caused by the deterioration of the goods to be traded over time, or may be information indicating the ratio of decrease in the amount of the goods in units of time.

[Hardware Configuration of Information Processing Device]

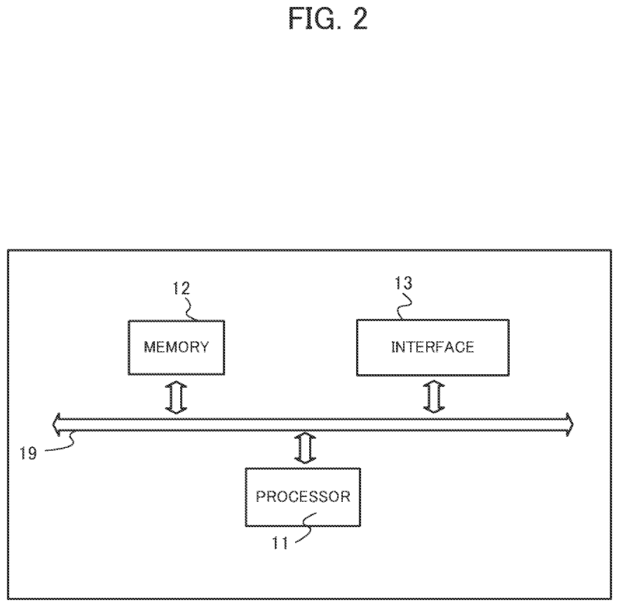

FIG. 2 shows the hardware configuration of the information processing device 1. The information processing device 1 includes a processor 11, a memory 12, and an interface 13 as hardware. The processor 11, the memory 12, and the interface 13 are connected to one another via a data bus 19.

The processor 11 executes a predetermined process by executing a program stored in the memory 12. The processor 11 is a processor such as a CPU (Central Processing Unit) and a GPU (Graphics Processing Unit).

The memory 12 is configured by various memories such as a RAM (Random Access Memory) and a ROM (Read Only Memory). In addition, a program for executing an optimization process executed by the information processing device 1 is stored in the memory 12. The memory 12 is used as a work memory and temporarily stores information acquired from the storage device 4. The memory 12 may function as a storage device 4. Similarly, the storage device 4 may function as a memory 12 of the information processing device 1. The program executed by the information processing device 1 may be stored in a storage medium other than the memory 12.

The interface 13 is an interface for electrically connecting the information processing device 1 and other devices. For example, the interface 13 includes an interface for connecting the information processing device 1 and the input device 2, an interface for connecting the information processing device 1 and the display device 3, and an interface for connecting the information processing device 1 and the storage device 4. For example, the interface for connecting the information processing device 1 and the storage device 4 is a communication interface such as a network adapter for wired or wireless transmission and reception of data to and from the storage device 4 under the control of the processor 11. In another example, the information processing device 1 and the storage device 4 may be connected by a cable or the like. In this case, the interface 13 includes an interface which conforms to USB, SATA (Serial AT Attachment) or the like for exchanging data with the storage device 4.

The hardware configuration of the information processing device 1 is not limited to the configuration shown in FIG. 2. For example, the information processing device 1 may include at least one of the input device 2 or the display device 3. Further, the information processing device 1 may be connected to or built in a sound output device such as a speaker. In this case, the information processing device 1 may be a tablet type terminal or the like in which the input function and the output function are integrated with the main body.

[Data Structure]

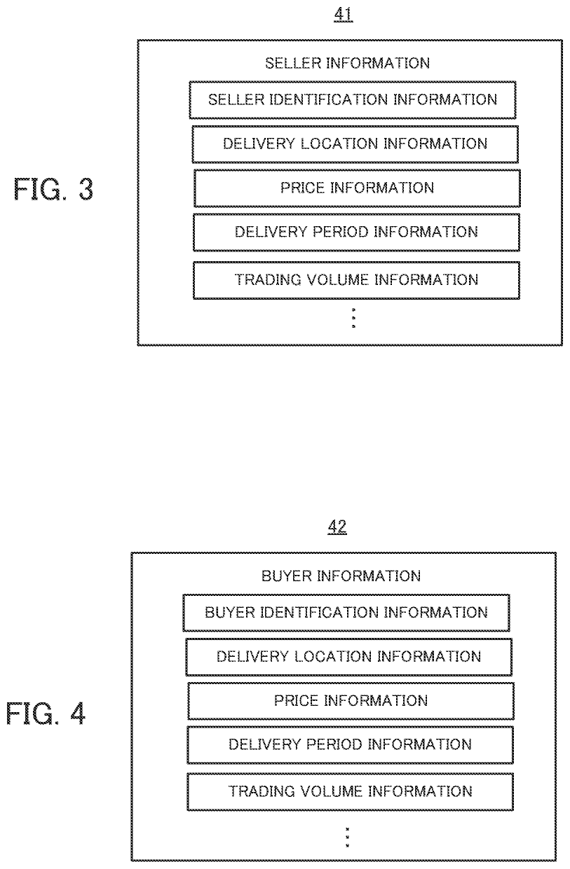

Next, an example of a data structure of various kinds of information stored in the storage device 4 will be described with reference to FIGS. 3 to 6.

FIG. 3 is an example of the data structure of seller information 41. The seller information 41 is information generated for each of the sellers of goods to be traded, and is information indicating the sell conditions (i.e., the terms of transaction desired by each seller) presented by each seller. Specifically, seller information 41 includes seller identification information, delivery location information, price information, delivery period information, loading port information, and trading volume information. Incidentally, the seller information 41 may be information indicating a table or a list having a record with respect to each seller.

The “seller identification information” is information that identifies each seller of goods to be traded. The seller identification information may include information on the attributes of each seller, such as the company name and location of each seller, in addition to the peculiar ID (seller ID) identifying each seller.

The “delivery location information” is information on the delivery location of the transaction target desired by each seller. For example, the delivery location information includes information indicating whether the delivery location is a port of loading or a port of discharge, and information regarding the port to be the delivery location.

The “price information” is information that indicates the price of goods to be traded desired by each seller. The “delivery period information” is information indicating the delivery period of the goods to be traded desired by each seller. The delivery period is generally set to a longer period as the schedule to delivery is ahead, and is determined in detail as it approaches the timing of delivery.

The “trading volume information” is information indicating the trading volume of goods desired by each seller. For example, the trading volume information is information indicating the lower limit and the upper limit of the trading volume of the goods desired by each seller, respectively. It is noted that when the goods to be traded is fuel, the trading amount is the amount of heat.

FIG. 4 is an example of the data structure of the buyer information 42. The buyer information 42 is information generated for each of the buyers of goods to be traded and indicates the buy conditions (i.e., the terms of purchase desired by each buyer) presented by each buyer. Specifically, the buyer information 42 includes buyer identification information, delivery location information, price information, delivery period information, discharging port information, and trading volume information. The buyer information 42 may be information indicating a table or a list having a record with respect to each buyer.

The “buyer identification information” is information that identifies each buyer of goods to be traded. The buyer identification information may include information on the attributes of each buyer, such as the company name and location of each buyer, in addition to the peculiar ID (buyer ID) identifying each buyer.

The “delivery location information” is information on the location of delivery of the transaction target desired by each buyer. For example, the delivery location information includes information indicating whether the delivery location is a port of loading or a port of discharge, and information regarding the port to be the delivery location.

The “price information” is information that indicates the price of goods to be traded desired by each buyer. The “delivery period information” is information indicating the delivery period of goods to be traded desired by each buyer. The delivery period is generally set to a longer period as the schedule to delivery is ahead, and is determined in detail as it approaches the timing of delivery.

The “trading volume information” is information that indicates the volume of traded goods desired by the target buyer. For example, the volume information is information indicating the lower limit and the upper limit of the trading volume of goods desired by the target buyer, respectively.

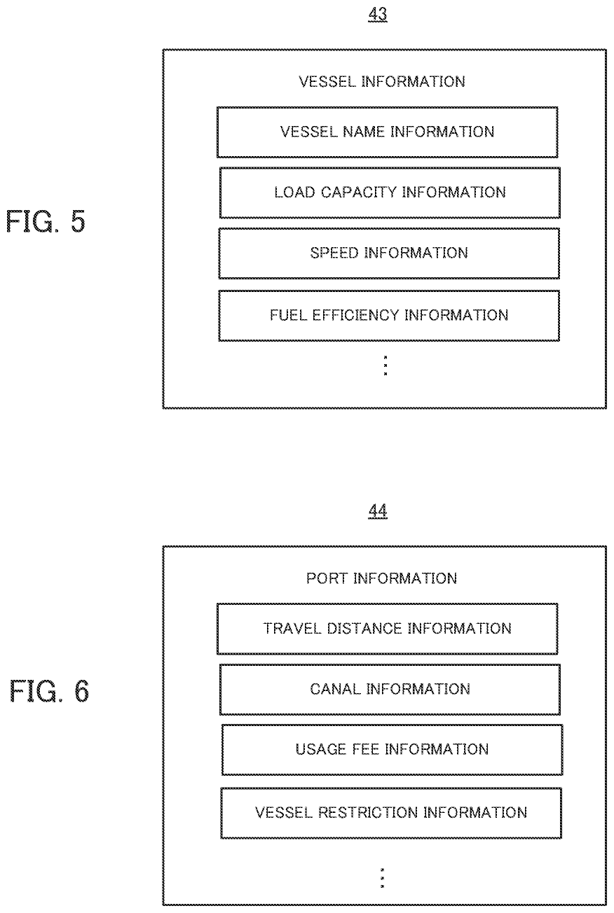

FIG. 5 is an example of the data structure of the vessel information 43. The vessel information 43 is information generated for each of the vessels that the user of the information processing device 1 can use, and mainly includes vessel name information, load capacity (burden) information, speed information, and fuel efficiency information. The vessel information 43 may be information indicating a table or a list having a record with respect to each vessel.

The “vessel name information” is information indicating the name of each vessel. The “load capacity information” is information that indicates the amount of goods that each vessel can load. The “speed information” is information on the speed of each vessel (e.g., maximum speed and average speed). The “fuel efficiency information” is information on the fuel efficiency of each vessel. Preferably, the fuel efficiency information is information indicating the fuel efficiency of each vessel in accordance with the speed.

It is noted that the vessel information 43 may be information on vessels (chartered vessels) which can be borrowed in a short term by the user of the information processing device 1. In this case, the vessel information 43 may further include information on the cost of the chartered vessel (such as the chartered cost per day, the fixed cost of the chartered vessel). The vessel information 43 may also further include information on the category of each vessel, information on the size of each vessel, and the like.

FIG. 6 is an example of the data structure of the port information 44. The port information 44 is information regarding a port that is a candidate for a port of loading or a port of discharge, including travel distance information, canal information, usage fee information, and vessel restriction information.

The “travel distance information” is information indicating the travel distance between ports. The travel distance information is, for example, a table information indicating the travel distance from a port of loading to a port of discharge with respect to each possible combination of a candidate port of loading and a candidate port of discharge.

The “canal information” is information that indicates the canals (e.g., Panama Canal and Suez Canal) where a toll to pass when traveling between ports occurs. The canal information is, for example, a table information indicating the canal to pass when moving from a port of loading to a port of discharge with respect to each possible combination of a candidate port of loading and a candidate port of discharge.

The “usage fee information” is information indicating a usage fee for each port. The usage fee information may also include information on the toll of the canal where the toll occurs.

The “vessel restriction information” is information indicating vessels that are not permitted to use each port. For example, the vessel restriction information is a table information indicating, for each port, the presence or absence of restrictions for each of the vessels that the user of the information processing device 1 can use.

[Functional Block]

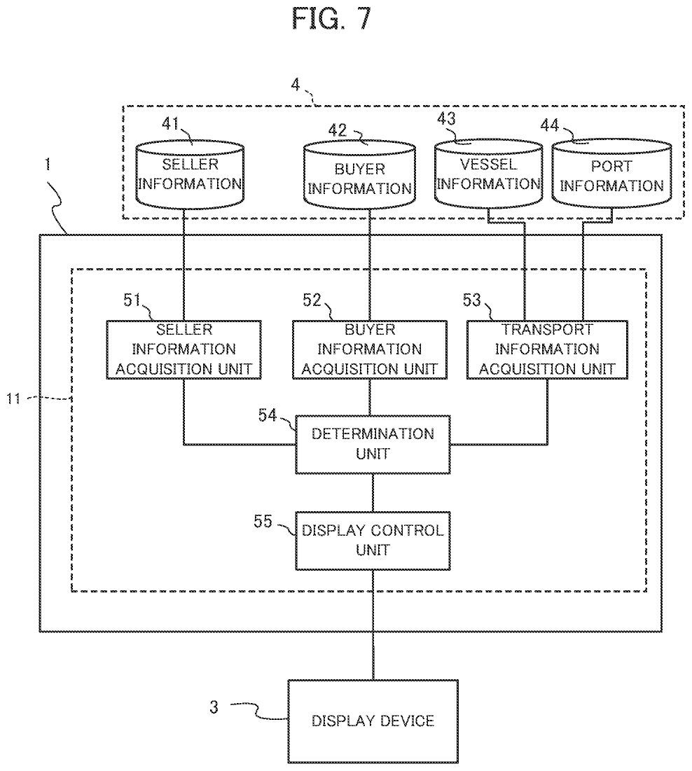

FIG. 7 is an example of a functional block of the information processing device 1 that executes an optimization process regarding the combinations (matching) of the sellers and the buyers and the transportation schedule by the vessels. The processor 11 of the information processing device 1 functionally includes a seller information acquisition unit 51, a buyer information acquisition unit 52, a transport information acquisition unit 53, a determination unit 54, and a display control unit 55.

The seller information acquisition unit 51 acquires seller information 41 corresponding to a plurality of sellers to be matched by referring to the storage device 4. Then, the seller information acquisition unit 51 supplies the acquired seller information 41 to the determination unit 54. Further, by referring to the storage device 4, the buyer information acquisition unit 52 acquires the buyer information 42 corresponding to a plurality of buyers to be matched. Then, the buyer information acquisition unit 52 supplies the acquired buyer information 42 to the determination unit 54.

In the case where the number of buyers and the number of sellers are not equal, the seller information acquisition unit 51 or the buyer information acquisition unit 52 may generate the tentatively generated seller information (also referred to as “tentative buyer information”) or the tentatively generated buyer information (also referred to as “tentative buyer information”). For example, if the number of the sellers is less than the number of the buyers, the seller information acquisition unit 51 generates tentative seller information, by the number of shortages, indicating typical (representative) trading conditions (such as price, delivery location, delivery period, and volume) desired by the sellers. Similarly, when the number of the buyers is less than the number of the sellers, the buyer information acquisition unit 52 generates tentative buyer information, by the number of shortages, indicating the typical (representative) trading conditions (such as price, delivery location, delivery period, and volume) desired by the buyers. It is noted that the delivery period indicated by the tentative seller information and the tentative buyer information may be set to be long enough to facilitate matching between the buyers and the sellers. The tentative seller information and tentative buyer information may be stored in advance in the storage device 4. At this time, for example, through the matching using the tentative seller information and the tentative buyer information, the user of the information processing device 1 can decide a guideline regarding whether or not to procure additional trade partners.

The transport information acquisition unit 53 acquires the vessel information 43 and the port information 44, which are information related to the transport of goods to be traded, by referring to the storage device 4. Then, the transport information acquisition unit 53 supplies the acquired vessel information 43 and the port information 44 to the determination unit 54. The vessel information 43 and the port information 44, respectively, are examples of transport information.

The determination unit 54 determines combinations of the sellers and the buyers which establish valid transactions and a transportation schedule based on the seller information 41 supplied by the seller information acquisition unit 51, the buyer information 42 supplied by the buyer information acquisition unit 52, and the transportation information supplied by the transportation information acquisition unit 53. In this case, the determination unit 54 optimizes the combinations of the sellers and the buyers which establish valid transactions and the transportation schedule so that the profit of the user of the information processing device 1 is maximized while satisfying the constraint conditions for the deal of the transaction target.

In this case, for example, the determination unit 54 considers a combinatorial optimization problem to determine the combinations of the sellers and the buyers and the transportation schedule to maximize the profit of the mediator and formulates it into an integer programming problem. In other words, the determination unit 54 formulates the combinations of the seller, the buyer, the vessels to be used, and the navigation period of the vessels as a combination optimization problem into an integer programming problem. The determination unit 54 obtains a solution on the formulated integer programming problem by performing a process equivalent to the process by a general application program (e.g., IBM ILOG CPLEX, Gurobi Optimizer, SCIP). Specifically, the determination unit 54 inputs constraints on the transactions and the transport in the form of linear integer constraints and a linear objective function that defines the profit to the above-described application program. Thereby, the determination unit 54 recognizes the transactions and the transport plan that maximizes the profit. In this case, the determination unit 54 also determines the delivery time and the trading volume and the like, at which the profit of the user is maximized. It is noted the assignment of vessels when transport is required can also be described as integer constraints.

In the above-described integer programming problem, the determination unit 54 sets the objective function representing the gross profit of the mediator and the linear integer constraints on the transactions and the transport based on the information on the price of the goods to be traded and the transportation date (the date of delivery).

Here, a description will be given of the conditions for the transactions and the transport, which are defined as linear integer constraints.

For example, the determination unit 54 determines a constraint condition for transactions to be a condition that the delivery period indicated by the delivery period information included in the seller information 41 is matched (consistent) with the delivery period indicated by the buyer information 42. In this case, if the goods to be traded are required to be transported, the determination unit 54 calculates the approximate number of navigation days taken to navigate from the port of loading designated by the seller to the port of discharge designated by the buyer, based on the vessel information 43 and the port information 44. The determination unit 54 determines whether or not it is possible to perform the delivery from the seller to the mediator (i.e., the user of the information processing device 1) during the delivery period designated by the seller and the delivery from the mediator to the buyer during the delivery period designated by the buyer, taking into consideration the calculated number of navigation days.

The number of navigation days indicating the length of the navigation period is the number of days required to move the vessel to the port of loading and the number of days required to transport the goods to be traded. Here, the determination unit 54 calculates the above-described number of days required for each vessel to undertake a transaction based on, for example, the loading port information included in the seller information 41 and the discharging port information included in the buyer information 42, the travel distance information included in the port information 44, and the speed information included in the vessel information 43.

For example, the appropriate difference in the delivery period required for establishing the matching depending on the travel distance can be described in the form of linear integer constraints as follows.

Now, by use of integers S and B, it is assumed that there are S sellers and B buyers, and that the seller's index is “s=1, 2, . . . , S” and the buyer's index is “b=1, 2, . . . , B.” It is also assumed that x_{s, b} is a variable with a value of either 0 or 1, and x_{s, b}=1 means to sell what is sourced from the seller s to the buyer b. In this case, the one-to-one correspondence between the seller and the buyer can be expressed as follows.

For each s=1, 2, . . . , S,

$${\sum }_{{b}^{′} = 1}^{B} {x}_{s , {b}^{′}} = 1$$

For each b=1, 2, . . . , B,

$${\sum }_{{s}^{′} = 1}^{S} {x}_{{s}^{′} , b} = 1$$

Here, the purchase time from the seller s is expressed by the variable “tₛ”, and similarly, the delivery time to the buyer b is expressed by the variable “t_{b}”. In addition, the duration of transport from the sellers to the buyer b is indicated by “d_{s, b}”. At this time, by using a sufficiently large positive constant “M”, the constraint that the transportation time is guaranteed can be expressed as follows.

With respect to each s=1, 2, . . . , S and each b=1, 2, . . . , B,

t_{b}−tₛ≥d_{s,b}x_{x,b}−M(1−x_{s,b})

This formula is explained as follows. If it is not transported from the seller s to the buyer b, the equation “x_{s, b}=0” is satisfied. At this time, since M is sufficiently large, the following inequality is always true and thus the constraint is deactivated.

t_{b}−tₛ≥−M

On the other hand, the equation “x_{s, b}=1” is satisfied when it is transported from the seller s to the buyer b. At this time, the following constraint is required.

t_{b}−tₛ≥d_{s,b}

This inequality means that a sufficient transit time is ensured.

Also, the constraint on the purchase (receipt) time is from the seller can be expressed as follows.

T_{s,1}≤tₛ≤T_{s,2}

This means that the receiving time must be between the time “T_{s, 1}” and the time “T_{s, 2}”.

In addition, the determination unit 54 assigns a vessel to be used for each transaction and determines the navigation period so that the delivery of goods from the seller during the delivery period indicated by the delivery period information included in the seller information 41 and the delivery of goods to the buyer during the delivery period indicated by the delivery period information included in the buyer information 42 can be carried out. The assignment of vessels can be described in the form of linear integer constraints as follows.

Now, it is assumed that “v=1, 2, . . . , V” is the index of the vessel and the variable “y_{s,v}” is a variable that is either 0 or 1 for the seller “s=1, 2, . . . , S”. Also, “y_{s,v}=1” represents a transaction with the seller s using the vessel v. At this time, the constraint of allocating one of the vessels to each transaction can be expressed as follows.

For each s=1, 2, . . . , S,

$${{\sum }^{V}}_{{v}^{′} = 1} {y}_{s , {v}^{′}} = 1$$

In addition, for each transaction of each seller s, “C(s)⊆{1, 2, . . . , S}” shall represent a seller who cannot transport goods by the same vessel as the vessel used in the transaction for the seller s. This means that, if the vessel v is allocated to the transaction of the seller s, the vessel v cannot arrive in time to the trading time of the other seller “s∈C(s)” included in C(s). At this time, such a constraint that the assignment of vessels does not collide among the transaction of multiple sellers can be expressed as follows using a sufficiently large positive constant M.

With respect to each s=1, 2, . . . , S and each v=1, 2, . . . , V,

$${\sum }_{{s}^{′} ∈ C ( s )} {y}_{{s}^{′} , v} \leq M ( 1 - {y}_{s , v} )$$

This constraint is explained as follows. If y_{s, v}=0 is satisfied and the vessel v is not assigned to the transaction of the seller s, the constraint is invalid because M is large enough. On the other hand, if y_{s, v}=1 is satisfied and the vessel v is assigned to the transaction of the seller s, then “y_{s′, v}=0” must be satisfied for the transaction of the seller s′ contained in C(s), which means that the vessel v is not assigned to the transaction of the other seller “s′∈C(s)”.

The actual implementation method is not limited to the above example. For example, while the above example deals with a case where the travel time is fixed and known in advance, constraints in the case where the speed of the vessel can be adjusted can be expressed in the same manner. Although the description was given of such an example that the collision of vessel assignments is expressed only by allocations to sellers, the constraints for cases where both sellers and buyers are affected by the collision of vessel assignments can also be described.

Further, for example, the determination unit 54 makes it a constraint condition of the transaction that the range of the trading volume indicated by the trading volume information included in the seller information 41 overlaps the range of the trading volume indicated by the trading volume information included in the buyer information 42.

Further, for example, the determination unit 54 makes it a constraint condition of the transaction that the price (i.e., the desired sale value) desired by the seller and the price (i.e., the desired purchase value) desired by the buyer satisfies a predetermined relation. In this case, for example, the above-described relation may be expressed by an expression or an inequality that defines that the desired sale value is within a predetermined ratio of the desired purchase value. In this case, for example, the determination unit 54 may determine the transaction price to be an intermediate value between the desired sale value and the desired purchase value, or may determine the transaction price based on a predetermined formula with the desired sale value and the desired purchase value determined in advance.

In addition to or in place of the above-described conditions, the determination unit 54 may be set linear integer constraints for various conditions necessary for establishing the transaction of the trading target.

Next, a supplemental description will be given of the profit of the user of the information processing device 1 that is a mediator, which is set as an objective function in the above-mentioned integer programming problem. For example, a predetermined percentage of the total amount of the transaction value is generated as the profit of the mediator. In addition, as will be described later, in the case of a transaction involving transport by the mediator, the amount corresponding to the fixed fee or the transport fee arises as the profit of the mediator. Therefore, when the combinations of the sellers and the buyers are determined, it is possible to determine the predicted value of the user's profit based on the transaction value. Accordingly, the determination unit 54 solves the above-described combinatorial optimization problem so that the predicted value of the profit of the mediator computed in this manner is maximized. The profit of the mediator can typically be formulated as the gross sales price minus the gross purchase price and transportation costs. Further, the determination unit 54 may determine the predicted value of the far-future profit (e.g., the predicted value of the profit at the time after a predetermined period or more) of the user by multiplying it by a decay rate that is less than 1.

For example, in the above-mentioned example, when the profit “p_{s, b}” of the delivery from the seller s to the buyer b and the cost “c_{s, v}” of the vessel v for the delivery from the seller s are given in advance, the gross profit (equal to the profit minus the cost of the transaction) can be expressed as follows.

$${{\sum }^{S}}_{s = 1} {{\sum }^{B}}_{b = 1} {p}_{s , b} {ϰ}_{s , b} - {{\sum }^{S}}_{s = 1} {{\sum }^{V}}_{v = 1} {c}_{s , v} {y}_{s , v}$$

By solving an integer programming problem, whose objective function is the above equation, based on linear constraints under the above constraints, a transportation schedule that maximizes the profit is calculated.

The above explanation is just an example, and the implementation is not limited thereto. For example, transport costs may include a variety of things, such as port usage costs and fuel costs, and may be rewritten in a manner that relies on buyers as well.

Further, the determination unit 54 may determine the transport schedule to maximize the profit of the user of the information processing device 1 in further consideration of the delivery location information included in the seller information 41, the delivery location information included in the buyer information 42, the travel distance information included in the port information 44, and the fuel efficiency information for each speed included in the vessel information 43. Thus, for example, the determination unit 54 determines a long navigation period so as to prioritize fuel efficiency over speed in such a transaction that there is a relatively large margin in the schedule of the vessel (i.e., the number of navigation days can be longer). Thereby, it is possible to increase the profit of the user of the information processing device 1. On the other hand, the determination unit 54 shortens the navigation period by giving priority to shortening the number of navigation days rather than the fuel efficiency in such a transaction that there is relatively little margin in the schedule of the vessel (i.e., when transaction using the target vessel are consecutive, and the like).

In addition, when goods that causes a loss with time is to be traded, the determination unit 54 acquires from the storage device 4 information on the amount of loss over the lapse of time regarding the goods in units of time, and determines a transportation schedule in further consideration of the information to maximize the profit of the user of the information processing device 1. Thereby, the determination unit 54 can determine the transportation schedule so that the profit of the user of the information processing device 1 is maximized even when goods such as LNG lost due to evaporation are to be traded.

Then, the determination unit 54 supplies the display control unit 55 with the information indicating the combinations of the sellers and the buyers, and the information on the schedule of each vessel, and the information indicative of profit/loss of the user of the information processing device 1 occurring for each transaction.

On the basis of the information received from the determination unit 54, the display control unit 55 generates display information S2 for displaying a view (also referred to as “matching confirmation view”) indicating the combination or the like of the sellers and the buyers determined by the determination unit 54. Then, the display control unit 55 displays on the display device 3 a matching confirmation view by supplying the generated display information S2 to the display device 3. The display example of the matching confirmation view will be described later.

[Matching Confirmation View]

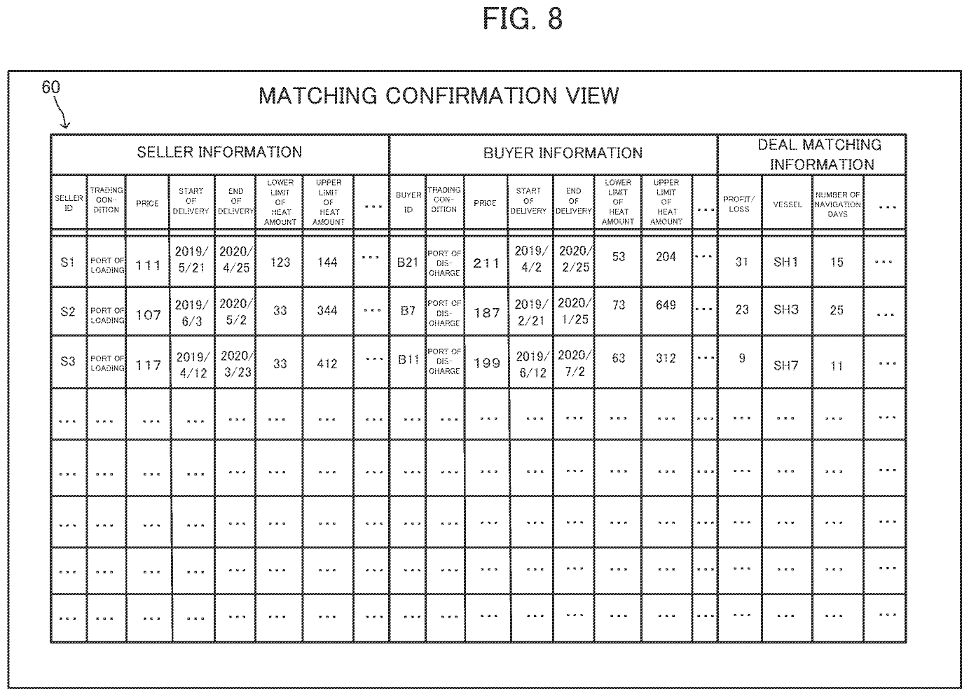

FIG. 8 is a display example of a matching confirmation view displayed by the display device 3 based on the control by the display control unit 55 of the information processing device 1. The display control unit 55 displays the matching table 60 on the matching confirmation view shown in FIG. 8. Here, as an example, the display control unit 55 displays on the display device 3 the matching confirmation view in the case where the transaction target is LNG.

The matching table 60 mainly has each major item of “SELLER INFORMATION”, “BUYER INFORMATION”, “DEAL MATCHING INFORMATION”. The major item “SELLER INFORMATION” includes sub-items of “SELLER ID”, “TRADING CONDITION”, “PRICE”, “START OF DELIVERY”, “END OF DELIVERY”, “LOWER LIMIT OF HEAT AMOUNT”, and “UPPER LIMIT OF HEAT AMOUNT”. The major item “BUYER INFORMATION” includes sub-items of “BUYER ID”, “TRADING CONDITION”, “PRICE”, “START OF DELIVERY”, “END OF DELIVERY”, “LOWER LIMIT OF HEAT AMOUNT”, and “UPPER LIMIT OF HEAT AMOUNT”. The major item “DEAL MATCHING INFORMATION” includes sub-items of “PROFIT/LOSS”, “VESSEL” and “NUMBER OF NAVIGATION DAYS”.

Here, the display control unit 55 generates each record of the matching table 60, for each combination (pair) of the seller and the buyer determined by the determination unit 54, based on the corresponding seller information 41 and buyer information 42. For example, the display control unit 55 displays the seller ID indicated by the seller identification information included in the corresponding seller information 41 in the item “SELLER ID”. Further, the display control unit 55 displays, in the item “TRADING CONDITION”, the information (herein, information indicating whether the delivery location is the port of loading or the port of discharge) indicative of the delivery location indicated by the delivery location information included in the seller information 41, and displays, in the item “PRICE”, the price indicated by the price information included in the seller information 41. Further, the display control unit 55 displays, in the items “START OF DELIVERY” and “END OF DELIVERY”, the start and end of the delivery period indicated by the delivery period information included in the seller information 41, respectively. Further, the display control unit 55 displays, in the items “LOWER LIMIT OF HEAT AMOUNT” and “UPPER LIMIT OF HEAT AMOUNT”, the lower limit and the upper limit of the trading volume indicated by the trading volume information included in the seller information 41, respectively. The display control unit 55 displays the buyer ID indicated by the buyer identification information included in the corresponding buyer information 42 in the item “BUYER ID”. Further, the display control unit 55 displays, in the item “TRADING CONDITION”, the information (herein, information indicating whether the delivery location is the port of loading or the port of discharge) indicative of the delivery location indicated by the delivery location information included in the buyer information 42, and displays, in the item “PRICE”, the price indicated by the price information included in the buyer information 42. Further, the display control unit 55 displays, in the items “START OF DELIVERY” and “END OF DELIVERY”, the start and end of the delivery period indicated by the delivery period information included in the buyer information 42, respectively. Further, the display control unit 55 displays, in the items “LOWER LIMIT OF HEAT AMOUNT” and “UPPER LIMIT OF HEAT AMOUNT”, the lower limit and the upper limit of the trading volume indicated by the trading volume information included in the buyer information 42, respectively.

Further, in addition to the information regarding the combinations of the sellers and the buyers, the display control unit 55 displays, in the item “DEAL MATCHING INFORMATION” with respect to each record in the matching table 60, the profit/loss and allocated vessels for the corresponding transactions. Specifically, the display control unit 55 displays, in the item of “PROFIT/LOSS”, the profit and loss calculated by the determination unit 54 for each transaction (i.e., pair of a seller and a buyer). Further, on the basis of the vessel name information included in the vessel information 43, the display control unit 55 displays, in the item “VESSEL”, the identification information of the vessel allocated for each transaction by the determination unit 54. Further, the display control unit 55 displays, in the item “NUMBER OF NAVIGATION DAYS”, the number of navigation days that the determination unit 54 has determined for each transaction. Further, the display control unit 55 may further include, in the item “DEAL MATCHING INFORMATION”, the item indicating the trading volume (heat amount) when the profit of the user of the information processing device 1 is maximized, the item indicating the delivery timing regarding the seller and the delivery timing regarding the buyer when the profit of the user is maximized, respectively. Such information is generated in the optimization process by the determination unit 54 and is supplied to the display control unit 55.

In this way, the information processing device 1 can suitably present to the user a list of seller and buyer combinations matched so that the profit of the user is maximized. Further, the information processing device 1 can suitably present to the user, together with the combinations of the seller and the buyer, the information on the vessels which are scheduled so that the profit of the user is maximized for each combination.

[Processing Flow]

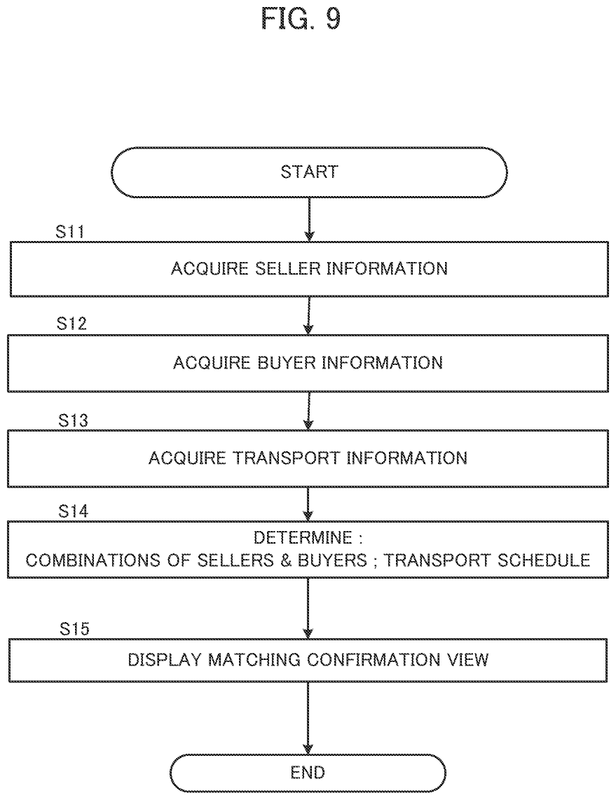

FIG. 9 is a flowchart showing the procedure of the optimization process according to the present example embodiment. The information processing device 1 executes the processing illustrated in FIG. 9, for example, when input information for instructing the display of the matching confirmation view is received from the input device 2.

First, the seller information acquisition unit 51 of the information processing device 1 acquires the seller information 41 corresponding to each of the sellers to be combined from the storage device 4 (step S11). Further, the buyer information acquisition unit 52 acquires the buyer information 42 corresponding to each of the buyers to be combined from the storage device 4 (step S12). Furthermore, the transport information acquisition unit 53 acquires the transport information relating to the transport including the vessel information 43 and the port information 44 from the storage device 4 (step S13).

Next, the determination unit 54 determines combinations of the sellers and the buyers serving as trading partners and a transport schedule, based on the seller information 41 acquired at step S11, the buyer information 42 acquired at step S12, and the transport information acquired at step S13 (step S14). In this case, the determination unit 54 combines the sellers and the buyers so that the profit of the user of the information processing device 1 is maximized, and determines the allocation of the vessels and each navigation period for the seller and buyer combinations requiring the transportation of goods.

Next, the display control unit 55 generates a display information S2 for displaying the matching confirmation view based on the execution result by the determination unit 54 and the seller information 41 and the buyer information 42. Then, the display control unit 55 supplies the display information S2 to the display device 3, to display the matching confirmation view on the display device 3 (step S15).

### Second Example Embodiment

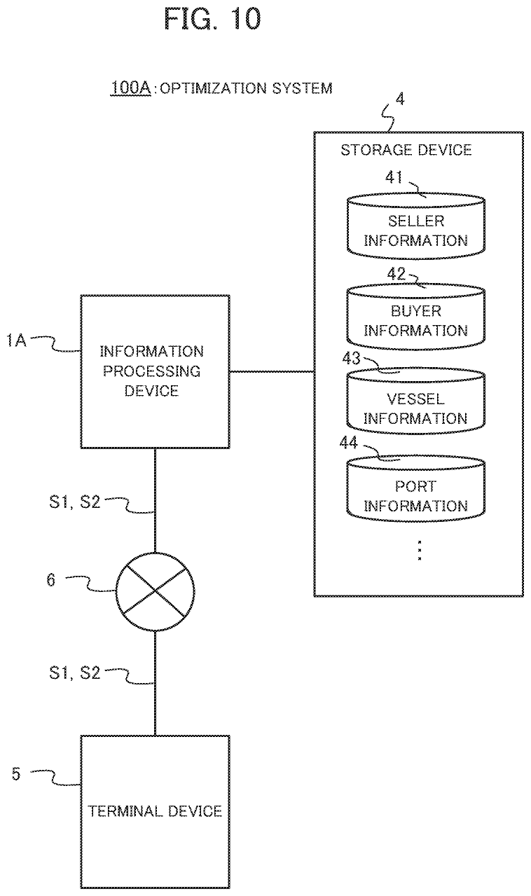

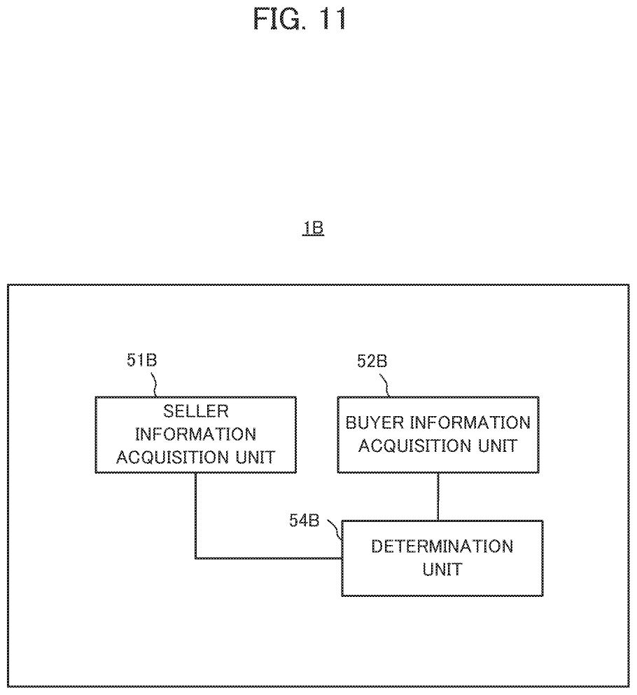

FIG. 10 shows a configuration of an optimization system 100A according to the second example embodiment. As shown in FIG. 10, the optimization system 100A mainly includes an information processing device 1A, a storage device 4, and a terminal device 5. The information processing device 1A and the terminal device 5 perform data communication with each other via the network 6.

The information processing device 1A has the same configuration as the information processing device 1 according to the first example embodiment and executes the same optimization processing as that of the information processing device 1. In this case, the information processing device 1A receives the input information 51, which the information processing device 1 receives from the input device 2 in the first example embodiment, from the terminal device 5 via the network 6. Further, the information processing device 1A sends the display information S2, which the information processing device 1 in the first example embodiment transmits to the display device 3, to the terminal device 5 via the network 6. Thus, the information processing device 1A according to the second example embodiment functions as a server device.

The terminal device 5 is a terminal equipped with an input function, a display function, and a communication function, and functions as an input device 2 and the display device 3 in the first example embodiment. Examples of the terminal device 5 include a personal computer, a tablet-type terminal, a PDA (Personal Digital Assistant) and the like. The terminal device 5 transmits the input information 51 generated based on the received user input to the information processing device 1A through the network 6. When receiving the display information S2 from the information processing device 1A, the terminal device 5 displays the matching confirmation view based on the display information S2.

As described above, the information processing device 1A according to the second example embodiment can suitably present, to the user of the terminal device 5, the list of the matched combinations of the sellers and the buyers so that the profit of the user is maximized. Further, along with the combinations of the sellers and the buyers, the information processing device 1A can suitably present, to the user of the terminal device 5, information associated with the vessels which are scheduled for the combinations so that the profit of the user is maximized.

### Third Example Embodiment

FIG. 10 is a functional block diagram of an information processing device 1B according to the third example embodiment. The information processing device 1B mainly includes a seller information acquisition unit 51B, a buyer information acquisition unit 52B, and a determination unit 54B.

The seller information acquisition unit 51B is configured to acquire seller information indicative of a sell condition of a transaction target, the sell condition being presented by each of a plurality of sellers. The buyer information acquisition unit 52B is configured to acquire buyer information indicative of a buy condition of the transaction target, the buy condition being presented by each of a plurality of buyers. The determination unit 54B is configured to determine combinations of each of the sellers and each of the buyers establishing the transaction, on the basis of the seller information acquired by the seller information acquisition unit 51B and the buyer information acquired by the buyer information acquisition unit 52B and a profit for a mediator mediating the transaction of the transaction target.

Given there are a plurality of sellers and a plurality of buyers, the information processing device 1B according to the third example embodiment can suitably determine the combinations of the sellers and the buyers in consideration of the profit for the mediator mediating the transaction of a transaction target.

The whole or a part of the example embodiments described above (including modifications, the same applies hereinafter) can be described as, but not limited to, the following Supplementary Notes.

[Supplementary Note 1]

An information processing device comprising:

a seller information acquisition unit configured to acquire seller information indicative of a sell condition of a transaction target, the sell condition being presented by each of a plurality of sellers;

a buyer information acquisition unit configured to acquire buyer information indicative of a buy condition of the transaction target, the buy condition being presented by each of a plurality of buyers; and

a determination unit configured to determine combinations of each of the sellers and each of the buyers establishing valid transactions, on a basis of the seller information, the buyer information, and a profit of a mediator mediating the transactions of the transaction target.

[Supplementary Note 2]

2. The information processing device according to Supplementary Note 1,

wherein the seller information includes information relating to a price and trading volume specified by the sellers,

wherein the buyer information includes information relating to a price and trading volume specified by the buyers, and

wherein the determination unit is configured to determine the combinations to maximize the profit of the mediator.

[Supplementary Note 3]

The information processing device according to Supplementary Note 1 or 2, further comprising

a transport information acquisition unit configured to acquire transport information relating to a transport of the transaction target from the sellers to the buyers,

wherein the determination unit is configured to determine the combinations and a schedule of the transport on the basis of the seller information, the buyer information, and the profit of the mediator, and the transport information.

[Supplementary Note 4]

The information processing device according to Supplementary Note 3,

wherein the transport information includes vessel information relating to vessels to be used for the transport, and

wherein the determination unit is configured to determine a vessel to be used for a transaction for which the transport of the transaction target is required.

[Supplementary Note 5]

The information processing device according to Supplementary Note 4,

wherein the vessel information includes information relating to respective capacities of the vessels and information relating to respective fuel efficiencies of the vessels, and

wherein the determination unit is configured to determine the combinations and the schedule of the transport to maximize the profit of the mediator.

[Supplementary Note 6]

The information processing device according to Supplementary Note 4 or Supplementary Note 5,

wherein the seller information includes information relating to respective delivery locations of the transaction target designated by the sellers,

wherein the buyer information includes information relating to respective delivery locations of the transaction target designated by the buyers,

wherein the transport information includes information relating to distances between the delivery locations designated by the sellers and the delivery locations designated by the buyers,

wherein the vessel information includes information relating to respective fuel efficiencies for the vessels in accordance with speeds, and

wherein the determination unit is configured to determine the combinations and the schedule of the transport to maximize the profit of the mediator.

[Supplementary Note 7]

The information processing device according to any one of Supplementary Notes 3 to 6,

wherein the transport target is goods that cause loss over time, and

wherein the determination unit is configured to determine the combinations and the schedule of the transport to maximize the profit of the mediator based on the information relating to the loss.

[Supplementary Note 8]

The information processing device according to any one of Supplementary Notes 1 to 7, further comprising

a display control unit configured to display information indicative of the combinations on the display device.

[Supplementary Note 9]

The information processing device according to any one of Supplementary Notes 1 to 8,

wherein the display control unit is configured to display, for each of the combinations on the display device, at least one of the profit of the mediator, a vessel to be used for the transport, and the number of navigation days of the vessel.

[Supplementary Note 10]

A control method executed by an information processing device, the control method comprising:

acquiring seller information indicative of a sell condition of a transaction target, the sell condition being presented by each of a plurality of sellers;

acquiring buyer information indicative of a buy condition of the transaction target, the buy condition being presented by each of a plurality of buyers; and

determining combinations of each of the sellers and each of the buyers establishing valid transactions, on a basis of the seller information, the buyer information, and a profit of a mediator mediating the transactions of the transaction target.

[Supplementary Note 11]

A storage medium storing a program executed by a computer, the program causing the computer to function as:

a seller information acquisition unit configured to acquire seller information indicative of a sell condition of a transaction target, the sell condition being presented by each of a plurality of sellers;

a buyer information acquisition unit configured to acquire buyer information indicative of a buy condition of the transaction target, the buy condition being presented by each of a plurality of buyers; and

a determination unit configured to determine combinations of each of the sellers and each of the buyers establishing valid transactions, on a basis of the seller information, the buyer information, and a profit of a mediator mediating the transactions of the transaction target.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A, 1B Information processing device
2 Input device
3 Display device
4 Storage device
5 Terminal device
100, 100A Optimization system

What is claimed is:

1. An information processing device comprising a memory configured to store a program and a processor configured to execute the program to:
acquire seller information indicative of a sell condition of a transaction target, the sell condition being presented by each of a plurality of sellers;
acquire buyer information indicative of a buy condition of the transaction target, the buy condition being presented by each of a plurality of buyers; and
determine combinations of each of the sellers and each of the buyers establishing valid transactions, on a basis of the seller information, the buyer information, and a profit of a mediator mediating the transactions of the transaction target.

2. The information processing device according to claim 1,
wherein the seller information includes information relating to a price and trading volume specified by the sellers,
wherein the buyer information includes information relating to a price and trading volume specified by the buyers, and
wherein the processor is configured to determine the combinations to maximize the profit of the mediator.

3. The information processing device according to claim 1,
wherein the processor is further configured to acquire transport information relating to a transport of the transaction target from the sellers to the buyers,
wherein the processor determination unit s configured to determine the combinations and a schedule of the transport on the basis of the seller information, the buyer information, and the profit of the mediator, and the transport information.

4. The information processing device according to claim 3,
wherein the transport information includes vessel information relating to vessels to be used for the transport, and
wherein the processor is configured to determine a vessel to be used for a transaction for which the transport of the transaction target is required.

5. The information processing device according to claim 4,
wherein the vessel information includes information relating to respective capacities of the vessels and information relating to respective fuel efficiencies of the vessels, and
wherein the processor is configured to determine the combinations and the schedule of the transport to maximize the profit of the mediator.

6. The information processing device according to claim 4,
wherein the seller information includes information relating to respective delivery locations of the transaction target designated by the sellers,
wherein the buyer information includes information relating to respective delivery locations of the transaction target designated by the buyers,
wherein the transport information includes information relating to distances between the delivery locations designated by the sellers and the delivery locations designated by the buyers,
wherein the vessel information includes information relating to respective fuel efficiencies for the vessels in accordance with speeds, and
wherein the processor is configured to determine the combinations and the schedule of the transport to maximize the profit of the mediator.

7. The information processing device according to claim 3,
wherein the transport target is goods that cause loss over time, and
wherein the processor is configured to determine the combinations and the schedule of the transport to maximize the profit of the mediator based on the information relating to the loss.

8. The information processing device according to claim 1,
wherein the processor is further configured to display information indicative of the combinations on the display device.

9. The information processing device according to claim 1,
wherein the processor is configured to display, for each of the combinations on the display device, at least one of the profit of the mediator, a vessel to be used for the transport, and the number of navigation days of the vessel.

10. A control method executed by an information processing device, the control method comprising:
acquiring seller information indicative of a sell condition of a transaction target, the sell condition being presented by each of a plurality of sellers;
acquiring buyer information indicative of a buy condition of the transaction target, the buy condition being presented by each of a plurality of buyers; and
determining combinations of each of the sellers and each of the buyers establishing valid transactions, on a basis of the seller information, the buyer information, and a profit of a mediator mediating the transactions of the transaction target.

11. A non-transitory computer readable storage medium storing a program executed by a computer, the program causing the computer to:
acquire seller information indicative of a sell condition of a transaction target, the sell condition being presented by each of a plurality of sellers;
acquire buyer information indicative of a buy condition of the transaction target, the buy condition being presented by each of a plurality of buyers; and
determine combinations of each of the sellers and each of the buyers establishing valid transactions, on a basis of the seller information, the buyer information, and a profit of a mediator mediating the transactions of the transaction target.
